(19) United States
(12) Patent Application Publication
(10) Pub. No.: US 2026/0300953 A1
(43) Pub. Date: Oct. 1, 2026

(54) TIME LIMITED DISPLAY OF PREDETERMINED SEQUENCE OF IMAGES WITH DEADMAN SWITCH ACTUATION FOR EVENT TICKET AUTHENTICATION USING SMARTPHONE

(71) Applicant: FASTBREAK.AI, INC., Charlotte, NC (US)

(72) Inventor: Raymond GLASSMANN, PALATINE, IL (US)

(21) Appl. No.: 19/575,820

(22) Filed: Mar. 23, 2026

Related U.S. Application Data
(60) Provisional application No. 63/780,163, filed on Mar. 28, 2025.

(51) Int. Cl. G06Q 20/32; G06Q 20/12

(52) U.S. Cl. CPC G06Q 20/3274; G06Q 20/1235

(57) ABSTRACT

A method for authenticating a ticket for admission to an event includes purchasing a ticket using an application on a smartphone or tablet; activating the ticket for use within a predetermined period of time; and presenting the smartphone or tablet to a ticket taker or other gatekeeper while a predetermined sequence of images is being displayed in order to gain admission to the event using the ticket. The smartphone or tablet only displays the predetermined sequence of images during the predetermined time after activation of the ticket, after which the ticket expires. A countdown timer is displayed showing the remaining time before ticket expiration. A deadman switch must be continuously engaged for the predetermined sequence of images to be displayed during the predetermined time. This may include pressing and holding the touchscreen of the smartphone or tablet for actuation of the deadman switch. The sequence preferably is event specific.

### COPYRIGHT STATEMENT

Any new and original work of authorship in this document is subject to copyright protection under the copyright laws of the United States and other countries. Reproduction by anyone of this document as it appears in official governmental records is permitted, but otherwise all other copyright rights whatsoever are reserved.

### BACKGROUND OF THE INVENTION

The invention generally relates to event ticketing and, in particular, the purchase and use of tickets for admission to a live event such as, for example, a sporting event such as a basketball game.

Conventional event ticketing systems, methods, and apparatus include the purchase and issuance of digital or electronic tickets for presentation on smartphones for admission to ticketed events. A drawback in some of these systems, methods, and apparatus includes the inability to determine if a ticket presented for admission is a genuine ticket or if it is a picture of screenshot of a genuine ticket. Another drawback in some of these systems, methods, and apparatus is that a person admitting ticket holders needs to have equipment capable of reading or scanning the electronic ticket being presented. It is believed that a need exists for simpler event ticketing systems, methods, and apparatus that utilizes electronic tickets but that betters defends against use of screenshots or pictures of electronic tickets and that does not require a ticket holder to utilize equipment for reading or scanning an electronic ticket. This is especially true for low revenue producing or free events, where the expense of more sophisticated ticketing systems, methods, and apparatus is unwarranted. It is believed that one or more of these needs are addressed by one or more aspects and features of the invention.

### SUMMARY OF THE INVENTION

The invention includes many aspects and features. Moreover, while many aspects and features relate to, and are described in, the context of sporting events, the invention is not limited to use only in such context, as will become apparent from the following summaries and detailed descriptions of aspects, features, and one or more embodiments of the invention. Thus, the invention equally finds utility and is intended for use with events such as plays, concerts, shows, speaking events, classes, exhibits, and performances.

Accordingly, in an aspect of the invention, a method for authenticating a ticket for admission to an event comprises: purchasing one or more tickets using an application on a portable electronic device; following said purchasing, receiving by the application on the portable electronic device instructions for displaying a predetermined sequence of images on the portable electronic device; activating the ticket for use within a predetermined period of time; and presenting the portable electronic device while the predetermined sequence of images is being displayed, in accordance with the received instructions, in order to gain admission to the event using the ticket, wherein the portable electronic device only displays, in accordance with the received instructions, the predetermined sequence of images during the predetermined time.

In a feature, the portable electronic device comprises a smartphone or tablet.

Preferably, the step of purchasing one or more tickets using an application on a portable electronic device comprises specifying a number of tickets and a phone number of the portable electronic device but not specifying a name, address, or email of a person who is purchasing the one or more tickets. Instead, such information preferably is obtained from one or more third parties based on the specified phone number. For example, name, address, and email preferably are obtained from a payment processing party that processes the credit card transaction and that already has stored this information in a database in association with the specified phone number.

In a feature, the application on the portable electronic device comprises a web browser through which a web application is utilized for purchasing the one or more tickets. The instructions for displaying the predetermined sequence of images preferably is received from the web application following a successful purchase of the one or more tickets, and the predetermined sequence of images preferably is displayed within the web browser.

In a feature, a remaining time of the predetermined period of time is displayed on the portable electronic device during the predetermined period of time.

In a feature, a remaining time of the predetermined period of time is continually displayed on the portable electronic device during the predetermined period of time.

In a feature, the predetermined period of time begins when the ticket is activated by the portable electronic device, in accordance with the received instructions, based on user input received by the portable electronic device.

In a feature, the predetermined period of time comprises a fixed period of time

In a feature, a remaining time of the predetermined period of time is displayed on the portable electronic device during the predetermined period of time.

In a feature, the remaining time of the predetermined period of time is displayed using a countdown timer

In a feature, the instructions for displaying the predetermined sequence of images is deleted from the portable electronic device immediately following the predetermined period of time

In a feature, the method further comprises, in accordance with the received instructions, presenting a user-selectable element in a GUI on the portable electronic device comprising a slide button for starting the predetermined period of time.

In a feature, the portable electronic device performs a method, in accordance with the received instructions, comprising the steps of: during the predetermined period of time (i) displaying the predetermined sequence of images on the portable electronic device, and (ii) not displaying the predetermined sequence of images on the portable electronic device, wherein the predetermined sequence of images is only displayed during actuation of a deadman switch on the portable electronic device; and not displaying the predetermined sequence of images outside of the predetermined period of time. The deadman switch may comprise a physical button on the portable electronic device that must be pressed and held for actuation of the deadman switch, or alternatively, the deadman switch may comprise a touchscreen on which the predetermined sequence of images is displayed, wherein the touchscreen must be continuously touched (pressed and held by a finger) for actuation of the deadman switch and consequent display of the predetermined sequence during the predetermined period of time.

In a feature, the method further comprises, in accordance with the received instructions, displaying a static graphic during the predetermined period of time when not displaying the predetermined sequence of images and not displaying the static graphic during the predetermined period of time when displaying the predetermined sequence of images.

In a feature, the predetermined sequence of images comprises a video clip.

In a feature, the predetermined sequence of images comprises animated graphics.

In a feature, the predetermined sequence of images comprises a display of a predetermined sequence of different colors.

In another aspect, a method for authenticating a ticket for admission to an event comprises: purchasing one or more tickets using an application on a portable electronic device; following said purchasing, receiving by the application on the portable electronic device instructions for displaying a predetermined sequence of images on the portable electronic device; and presenting the portable electronic device while the predetermined sequence of images is being displayed, in accordance with the received instructions, in order to gain admission to the event using the ticket, wherein the portable electronic device only displays, in accordance with the received instructions, the predetermined sequence of images during actuation of a deadman switch on the portable electronic device. The deadman switch may comprise a physical button on the portable electronic device that must be pressed and held for actuation of the deadman switch, or alternatively, the deadman switch may comprise a touchscreen on which the predetermined sequence of images is displayed in the web browser, wherein the touchscreen must be continuously touched (pressed and held by a finger) for actuation of the deadman switch and consequent display of the predetermined sequence.

In a feature, the portable electronic device comprises a smartphone or tablet.

In a feature, the predetermined sequence of images comprises a video clip.

In a feature, the predetermined sequence of images comprises animated graphics.

In a feature, the predetermined sequence of images comprises a display of a predetermined sequence of different colors.

In a feature, the step of purchasing one or more tickets using an application on a portable electronic device comprises specifying a number of tickets and a phone number of the portable electronic device. Furthermore, the purchasing of the one or more tickets preferably does not comprise specifying a name, address, or email of a person who is purchasing the one or more tickets. Instead, such information preferably is obtained from one or more third parties based on the specified phone number. For example, name, address, and email preferably are obtained from a payment processing party that processes the credit card transaction and that already has stored this information in a database in association with the specified phone number.

In a feature, the application on the portable electronic device comprises a web browser through which a web application is utilized for purchasing the one or more tickets.

Furthermore, the instructions for displaying the predetermined sequence of images preferably is received from the web application following a successful purchase of the one or more tickets, and the predetermined sequence of images preferably is displayed within the web browser.

In another aspect, a method for authenticating a ticket for admission to an event comprises: purchasing one or more tickets using an application on a portable electronic device; following said purchasing, receiving by the application on the portable electronic device instructions for displaying a predetermined sequence of images on the portable electronic device; and presenting the portable electronic device while the predetermined sequence of images is being displayed, in accordance with the received instructions, in order to gain admission to the event using the ticket, wherein the portable electronic device only displays, in accordance with the received instructions, the predetermined sequence of images during actuation of a deadman switch on the portable electronic device, and wherein the portable electronic device only displays, in accordance with the received instructions, the predetermined sequence of images during a predetermined time.

In a feature, a remaining time of the predetermined period of time is displayed on the portable electronic device during the predetermined period of time.

In a feature, a remaining time of the predetermined period of time is continually displayed on the portable electronic device during the predetermined period of time.

In a feature, the predetermined period of time begins when the ticket is activated by the portable electronic device, in accordance with the received instructions, based on user input received by the portable electronic device.

In a feature, the instructions for displaying the predetermined sequence of images is deleted from the portable electronic device immediately following the predetermined period of time.

In a feature, the predetermined period of time comprises a fixed period of time, such as 3 minutes.

In a feature, a remaining time of the predetermined period of time is displayed on the portable electronic device during the predetermined period of time.

In a feature, the remaining time of the predetermined period of time is displayed using a countdown timer.

In a feature, the method further comprises, in accordance with the received instructions, presenting a user-selectable element in a GUI on the portable electronic device comprising a slide button for starting the predetermined period of time.

In a feature, the method further comprises, in accordance with the received instructions, displaying a static graphic during the predetermined period of time when not displaying the predetermined sequence of images and not displaying the static graphic during the predetermined period of time when displaying the predetermined sequence of images.

In another aspect, a method that is performed on a client-side portable electronic device for visual authentication of a ticketholder using the portable electronic device comprises: receiving from a server-side web application instructions for displaying a predetermined sequence of images in a web browser on the client-side portable electronic device; in accordance with the received instructions during a predetermined period of time, displaying the predetermined sequence of images in the web browser on the portable electronic device, and not displaying the predetermined sequence of images in the web browser on the portable electronic device, wherein the predetermined sequence of images is only displayed in the web browser during actuation of a deadman switch on the portable electronic device; and not displaying the predetermined sequence of images in the web browser outside of the predetermined period of time. The method further comprises presenting the portable electronic device during the predetermined period of time for authentication by demonstrating actuation of the deadman switch and the display of the predetermined sequence of images by the portable electronic device in accordance with the received instructions.

The deadman switch may comprise a physical button on the portable electronic device that must be pressed and held for actuation of the deadman switch, or alternatively, the deadman switch may comprise a touchscreen on which the predetermined sequence of images is displayed in the web browser, wherein the touchscreen must be continuously touched (pressed and held by a finger) for actuation of the deadman switch and consequent display of the predetermined sequence during the predetermined period of time.

In a feature, the portable electronic device comprises a smartphone or tablet.

In a feature, the instructions for displaying the predetermined sequence of images is deleted from the portable electronic device immediately following the predetermined period of time.

In a feature, the predetermined period of time comprises a fixed period of time.

In a feature, a remaining time of the predetermined period of time is displayed on the portable electronic device during the predetermined period of time. The remaining time of the predetermined period of time preferably is displayed using a countdown timer.

In a feature, the method further comprises, in accordance with the received instructions, presenting a user-selectable element in a GUI on the portable electronic device comprising a slide button for starting the predetermined period of time.

In a feature, the method further comprises, in accordance with the received instructions, displaying a static graphic during the predetermined period of time when not displaying the predetermined sequence of images and not displaying the static graphic during the predetermined period of time when displaying the predetermined sequence of images.

In a feature, the predetermined sequence of images comprises a video clip.

In a feature, the predetermined sequence of images comprises animated graphics.

In a feature, the predetermined sequence of images comprises a display of a predetermined sequence of different colors.

In addition to the aforementioned aspects and features of the invention, it should be noted that the invention further encompasses the various logical combinations and subcombinations of such aspects and features. Thus, for example, claims in this or a divisional or continuing patent application or applications may be separately directed to any aspect, feature, or embodiment disclosed herein, or combination thereof, without requiring any other aspect, feature, or embodiment.

### BRIEF DESCRIPTION OF THE DRAWINGS

One or more preferred embodiments of the invention now will be described in detail with reference to the accompanying drawings.

FIG. 1. Illustrates a preferred system architecture of one or more preferred embodiments in accordance with one or more aspects and features of the invention.

FIGS. 2-6 each illustrates steps in a respective method of one or more preferred embodiments in accordance with one or more aspects and features of the invention.

FIGS. 7-20 each illustrates a screenshot of a frontend client device displaying a GUI as generated by a client-side web browser in accordance with computer-executable instructions received from a server-side web application.

### DETAILED DESCRIPTION

As a preliminary matter, it will readily be understood by one having ordinary skill in the relevant art (“Ordinary Artisan”) that the invention has broad utility and application. Furthermore, any embodiment discussed and identified as being “preferred” is considered to be part of a best mode contemplated for carrying out the invention. Other embodiments also may be discussed for additional illustrative purposes in providing a full and enabling disclosure of the invention. Furthermore, an embodiment of the invention may incorporate only one or a plurality of the aspects of the invention disclosed herein; only one or a plurality of the features disclosed herein; or combination thereof. As such, many embodiments are implicitly disclosed herein and fall within the scope of what is regarded as the invention.

Accordingly, while the invention is described herein in detail in relation to one or more embodiments, it is to be understood that this disclosure is illustrative and exemplary of the invention and is made merely for the purposes of providing a full and enabling disclosure of the invention. The detailed disclosure herein of one or more embodiments is not intended, nor is to be construed, to limit the scope of patent protection afforded the invention in any claim of a patent issuing here from, which scope is to be defined by the claims and the equivalents thereof. It is not intended that the scope of patent protection afforded the invention be defined by reading into any claim a limitation found herein that does not explicitly appear in the claim itself.

Thus, for example, any predetermined sequence(s) and/or temporal order of steps of various processes or methods that are described herein are illustrative and not restrictive. Accordingly, it should be understood that, although steps of various processes or methods may be shown and described as being in a predetermined sequence or temporal order, the steps of any such processes or methods are not limited to being carried out in any particular predetermined sequence or order, absent an indication otherwise. Indeed, the steps in such processes or methods generally may be carried out in various different predetermined sequences and orders while still falling within the scope of the invention. Accordingly, it is intended that the scope of patent protection afforded the invention be defined by the issued claim(s) rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

With regard solely to construction of any claim with respect to the United States, no claim element is to be interpreted under 35 U.S.C. 112(f) unless the explicit phrase “means for” or “step for” is actually used in such claim element, whereupon this statutory provision is intended to and should apply in the interpretation of such claim element. With regard to any method claim including a condition precedent step, such method requires the condition precedent to be met and the step to be performed at least once but not necessarily every time during performance of the claimed method.

Furthermore, it is important to note that, as used herein, “comprising” is open-ended insofar as that which follows such term is not exclusive. Additionally, “a” and “an” each generally denotes “at least one” but does not exclude a plurality unless the contextual use dictates otherwise. Thus, reference to “a picnic basket having an apple” is the same as “a picnic basket comprising an apple” and “a picnic basket including an apple”, each of which identically describes “a picnic basket having at least one apple” as well as “a picnic basket having apples”; the picnic basket further may contain one or more other items beside an apple. In contrast, reference to “a picnic basket having a single apple” describes “a picnic basket having only one apple”; the picnic basket further may contain one or more other items beside an apple. In contrast, “a picnic basket consisting of an apple” has only a single item contained therein, i.e., one apple; the picnic basket contains no other item.

When used herein to join a list of items, “or” denotes “at least one of the items” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers”; the picnic basket further may contain one or more other items beside cheese and crackers.

When used herein to join a list of items, “and” denotes “all of the items of the list”. Thus, reference to “a picnic basket having cheese and crackers” describes “a picnic basket having cheese, wherein the picnic basket further has crackers”, as well as describes “a picnic basket having crackers, wherein the picnic basket further has cheese”; the picnic basket further may contain one or more other items beside cheese and crackers.

The phrase “at least one” followed by a list of items joined by “and” denotes an item of the list but does not require every item of the list. Thus, “at least one of an apple and an orange” encompasses the following mutually exclusive scenarios: there is an apple but no orange; there is an orange but no apple; and there is both an apple and an orange. In these scenarios if there is an apple, there may be more than one apple, and if there is an orange, there may be more than one orange. Moreover, the phrase “one or more” followed by a list of items joined by “and” is the equivalent of “at least one” followed by the list of items joined by “and”.

Additionally, as used herein, “web application” or “web app” denotes a software program that runs on a web server and is accessed over the Internet by users through web browsers on client devices, offering interactive functionality and accessible from any user device with a browser and Internet connection. The data processing of the web app occurs on the web server, and the user interface is rendered on the client-side in the web browser. When a web app is accessed, the browser sends a request to the server, which then sends back the necessary code and data needed to display the application in the browser on the user device. Specifically, users interact with web apps by accessing their URLs in a web browser. Web applications run on specific web servers in a back-end infrastructure and do not require local installations or updates on user devices.

As used herein, a “graphical user interface” or “GUI” denotes an interface by which user input is received on a client device and that includes a one or more graphical and textual elements that are presented on a screen in accordance with computer-executable instructions. Each graphical or textual element may be user-selectable by which user input is received. Such an element may be, for example, in the form of a button or a text box for inputting text.

Referring now to the drawings, one or more preferred embodiments of the invention are next described. The following description of one or more preferred embodiments is merely exemplary in nature and is in no way intended to limit the invention, its implementations, or uses.

Referring to the drawings, one or more preferred embodiments of the invention are next described. The following description of one or more preferred embodiments is merely exemplary in nature and is in no way intended to limit the invention, its implementations, or uses.

The invention is now described in the context of preferred systems, methods, apparatus, and computer-executable instructions contained in non-transitory computer readable medium. These preferred embodiments generally relate to ticketing comprising the purchase and use of tickets for events such as sports games, plays, concerts, shows, speaking events, classes, exhibits, and performances.

Preferred embodiments utilize secure software ticketing application in the form of web-based applications that run server-side and that enable users to use tickets for admission to events utilizing graphical user interfaces on frontend client devices and, preferably, portable electronic devices such as smartphones. These web-based GUIs are generated by web browsers that run on the frontend client devices in accordance with the web-based applications. The backend computer systems preferably comprise application servers, database servers, and web servers. The frontend client devices preferably smartphones and may comprise tablets. Most preferably, the web applications and web-based GUIs are optimized for use with smartphones, such as the iPhone made by Apple Inc.

By using web apps, issues of hardware dependencies for barcode and QR code scanning are avoided. This streamlines the ticketing process, reducing setup time and costs for event organizers. Attendees benefit from increased convenience, as they can easily access their tickets directly from their smartphones, eliminating the need for physical tickets or additional scanning devices. Moreover, conventional web applications have robust security features that ensure the protection of sensitive information, safeguarding against fraud and unauthorized access.

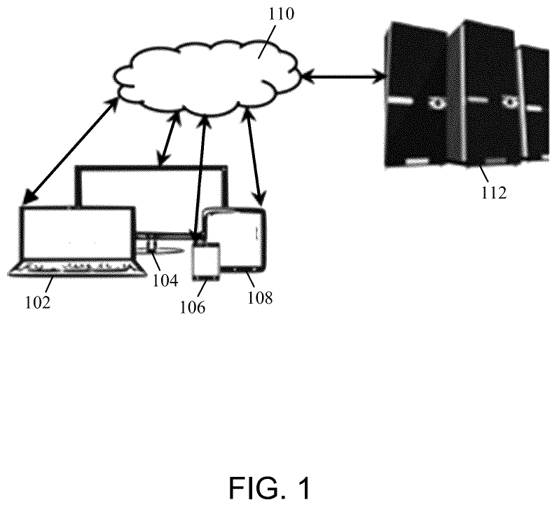

The preferred architecture for systems of the invention is illustrated in FIG. 1, wherein a representative laptop 102, desktop 104, smartphone 106, and tablet 108 are shown in network communication over the Internet 110 with servers 112. The server 112 runs the web-based, server-side application. In contrast, the web-based GUIs are provided on the client-side devices through web browsers that run on the client devices. The collection of servers represented by servers 112 are generally referred to by the Ordinary Artisan as a backend computer system and are commonly understood to comprise one or more web servers, application servers, and database servers.

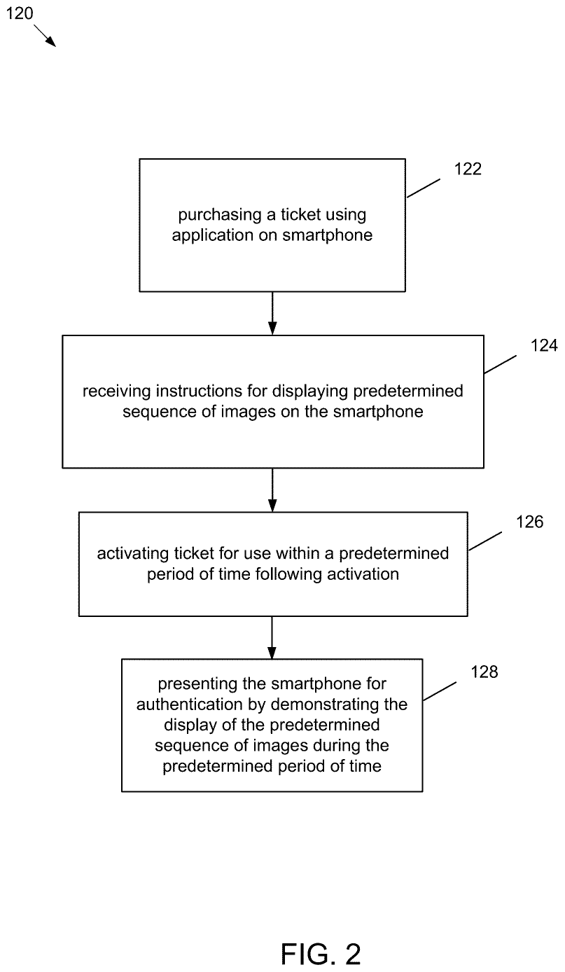

In accordance with some preferred embodiments of a first aspect of the invention, steps of a method 120 for authenticating a digital or electronic ticket for admission to an event are illustrated in FIG. 2. Briefly stated, these steps include: step 122, comprising a step of purchasing a ticket using an application on a smartphone; step 124, comprising a step of receiving instructions for displaying predetermined sequence of images on the smartphone; step 126, comprising a step of activating the ticket for use within a predetermined period of time following activation; and step 128, comprising a step of presenting the smartphone for authentication by demonstrating the display of the predetermined sequence of images during the predetermined period of time.

In greater detail, and speaking more broadly, the method 120 comprises: purchasing one or more tickets using an application on a portable electronic device; following said purchasing, receiving by the application on the portable electronic device instructions for displaying a predetermined sequence of images on the portable electronic device; activating the ticket for use within a predetermined period of time; and presenting the portable electronic device while the predetermined sequence of images is being displayed, in accordance with the received instructions, in order to gain admission to the event using the ticket, wherein the portable electronic device only displays, in accordance with the received instructions, the predetermined sequence of images during the predetermined time. Demonstrating the display of the predetermined sequence of images during the predetermined period of time authenticates the purchased one or more tickets for admission to the event. The one or more purchased tickets expire and can no longer be used after the predetermined period of time. Preferably the predetermined period of time is 10 minutes or less and, more preferably, the predetermined period of time is 3 minutes.

In accordance with other preferred embodiments, computer-executable instructions contained in a non-transitory computer readable medium perform method 120, and systems and apparatus are configured to perform method 120.

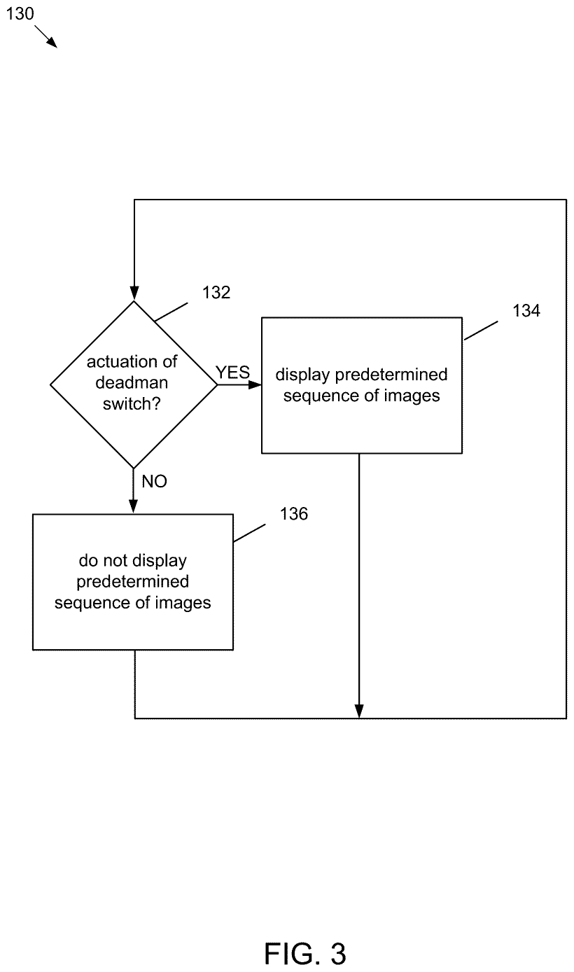

In accordance with some preferred embodiments of another aspect of the invention, steps of a method 130 for authenticating a digital or electronic ticket for admission to an event are illustrated in FIG. 3. Briefly stated, these steps include: step 132, comprising a step of determining whether a deadman switch of the smartphone is actuated; step 134, comprising displaying the predetermined sequence of images if the determination in step 132 is affirmative; and step 136, comprising a step of not displaying the predetermined sequence of images if the determination in step 132 is affirmative. These steps of method 130 repeat on a loop.

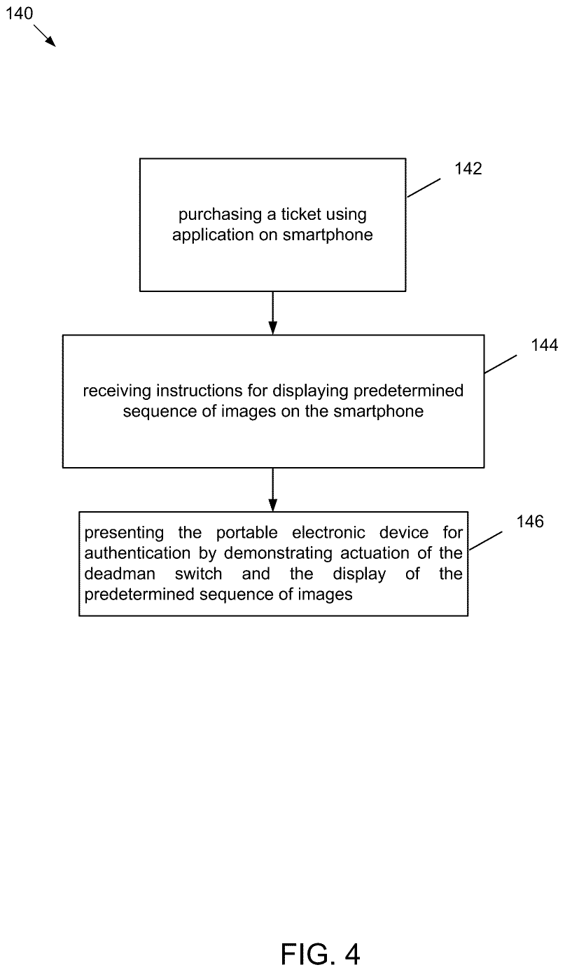

The steps of method 130 preferably are substeps of method 140, steps of which are illustrated in FIG. 4. Briefly stated, the steps of FIG. 4 include: step 142, comprising a step of purchasing a ticket using application on smartphone; step 144, comprising a step of receiving instructions for displaying the predetermined sequence of images on the smartphone; and step 146, comprising a step of presenting the portable electronic device for authentication by demonstrating actuation of the deadman switch and the display of the predetermined sequence of images.

In greater detail, and speaking more broadly, the method 140 comprises: method for authenticating a ticket for admission to an event, comprising: purchasing one or more tickets using an application on a portable electronic device; following said purchasing, receiving by the application on the portable electronic device instructions for displaying a predetermined sequence of images on the portable electronic device; and presenting the portable electronic device while the predetermined sequence of images is being displayed, in accordance with the received instructions, in order to gain admission to the event using the ticket, wherein the portable electronic device only displays, in accordance with the received instructions, the predetermined sequence of images during actuation of a deadman switch on the portable electronic device. Demonstrating the display of the predetermined sequence of images authenticates the purchased one or more tickets for admission to the event.

The deadman switch may comprise a physical button on the portable electronic device that must be pressed and held for actuation of the deadman switch, in accordance with method 130. Alternatively, the deadman switch may comprise a touchscreen on which the predetermined sequence of images is displayed in the web browser, wherein the touchscreen must be continuously touched for actuation of the deadman switch, in accordance with method 130.

In accordance with other preferred embodiments, computer-executable instructions contained in a non-transitory computer readable medium perform method 140, and systems and apparatus are configured to perform method 140.

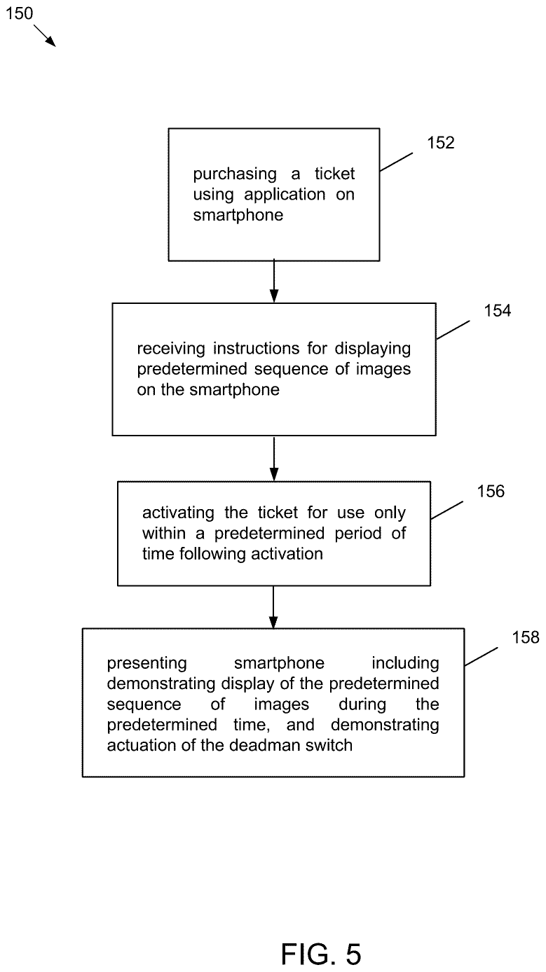

In accordance with some preferred embodiments of another aspect of the invention, steps of a method 150 for authenticating a digital or electronic ticket for admission to an event are illustrated in FIG. 5.

Briefly stated, these steps include: step 152, comprising a step of purchasing a ticket using application on smartphone; step 154, comprising a step of receiving instructions for displaying predetermined sequence of images on the smartphone; step 156, comprising a step of activating the ticket for use only within a predetermined period of time following activation; and step 158, comprising a step of presenting the smartphone including demonstrating display of the predetermined sequence of images during the predetermined period of time, and demonstrating actuation of the deadman switch. It will thus be appreciated that method 150 generally represents the combination of methods 120 and 140. Demonstrating the display of the predetermined sequence of images during the predetermined period of time and demonstrating the actuation of the deadman switch authenticates the purchased one or more tickets for admission to the event.

In greater detail, and speaking more broadly, the method 150 for authenticating a ticket for admission to an event comprises: purchasing one or more tickets using an application on a portable electronic device; following said purchasing, receiving by the application on the portable electronic device instructions for displaying a predetermined sequence of images on the portable electronic device; and presenting the portable electronic device while the predetermined sequence of images is being displayed, in accordance with the received instructions, in order to gain admission to the event using the ticket, wherein the portable electronic device only displays, in accordance with the received instructions, the predetermined sequence of images during actuation of a deadman switch on the portable electronic device.

In accordance with other preferred embodiments, computer-executable instructions contained in a non-transitory computer readable medium perform method 150, and systems and apparatus are configured to perform method 150.

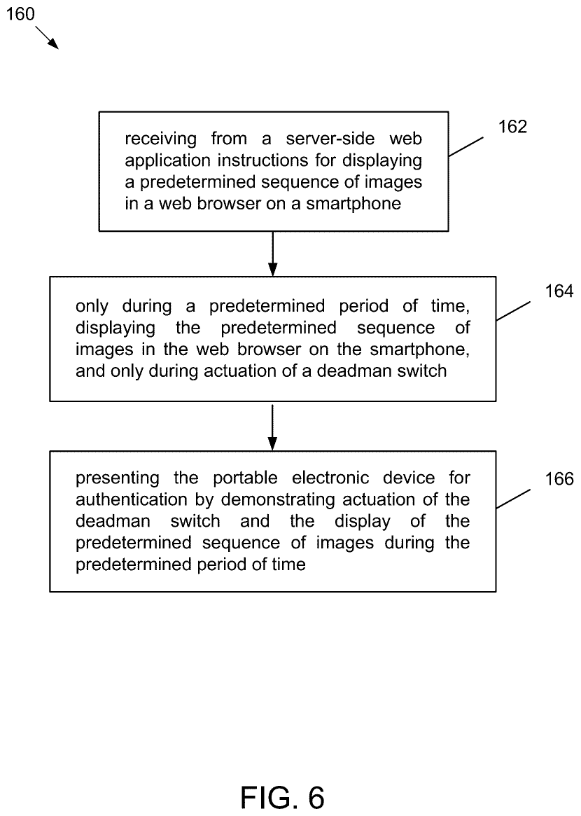

In accordance with some preferred embodiments of another aspect of the invention, steps of a method 160 for authenticating a digital or electronic ticket for admission to an event are illustrated in FIG. 6. Briefly stated, these steps include: step 162, comprising a step of receiving from a server-side web application instructions for displaying a predetermined sequence of images in a web browser on a smartphone; step 164, comprising a step of only during a predetermined period of time, displaying the predetermined sequence of images in the web browser on the smartphone, and only during actuation of a deadman switch; and step 166, comprising a step of presenting the portable electronic device for authentication by demonstrating actuation of the deadman switch and the display of the predetermined sequence of images during the predetermined period of time.

In greater detail, and speaking more broadly, the method 160 is performed on a client-side portable electronic device for visual authentication of a ticketholder using the portable electronic device. The method 160 comprises receiving from a server-side web application instructions for displaying a predetermined sequence of images in a web browser on the client-side portable electronic device; in accordance with the received instructions, and during a predetermined period of time, displaying the predetermined sequence of images in the web browser on the portable electronic device only during actuation of a deadman switch on the portable electronic device; and presenting the portable electronic device during the predetermined period of time for authentication by demonstrating actuation of the deadman switch and the display of the predetermined sequence of images by the portable electronic device in accordance with the received instructions.

The method preferably further includes not displaying the predetermined sequence of images in the web browser outside of the predetermined period of time.

In accordance with other preferred embodiments, computer-executable instructions contained in a non-transitory computer readable medium perform method 160, and systems and apparatus are configured to perform method 160.

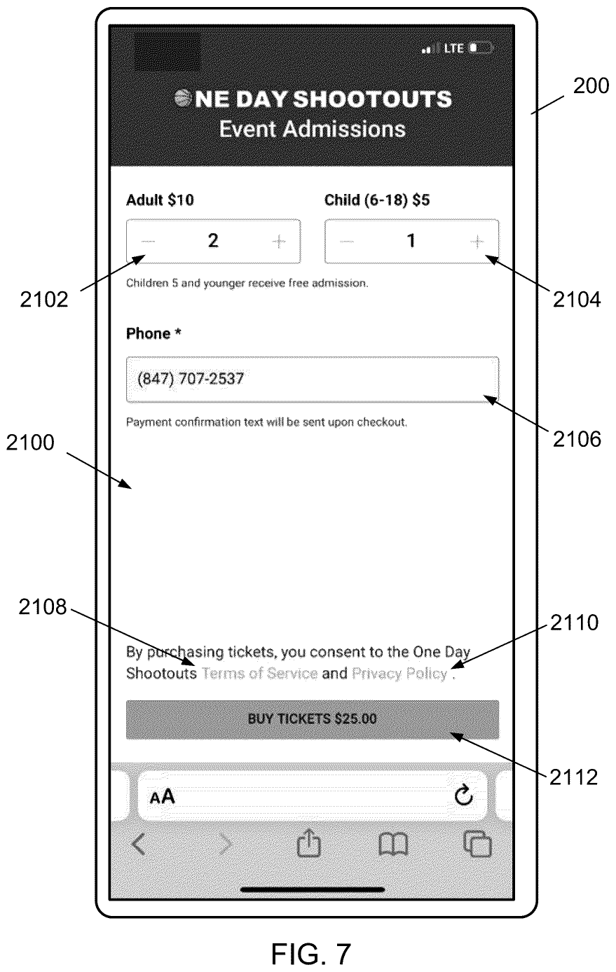

FIGS. 7-20 each illustrates a screenshot of a frontend client device displaying a GUI as generated by a client-side web browser in accordance with code and data received from a server-side web application. The web application of this example preferably is utilized in the purchasing and the use of a ticket to gain admission to an event, in this case a basketball shootout event.

In FIG. 7, GUI 202 comprises user-selectable input element 2102 for specifying the number of tickets to be purchased each for an adult; user-selectable input element 2104 for specifying the number of tickets to be purchased each for an child; user-selectable input element 2106 for specifying the telephone number of the purchaser, which preferably is a telephone number for texting and/or calling the frontend client device 200; user-selectable input element 2108 for viewing terms of service; user-selectable input element 2110 for a privacy policy; and user-selectable input element 2112 in the form of a “Buy Tickets $25.00” button for buying the number of specified adult and child tickets. These elements 2102, 2104, 2106, 2108, 2110, and 2112 are provided by the web browser in accordance with computer-executable instructions received from the web application.

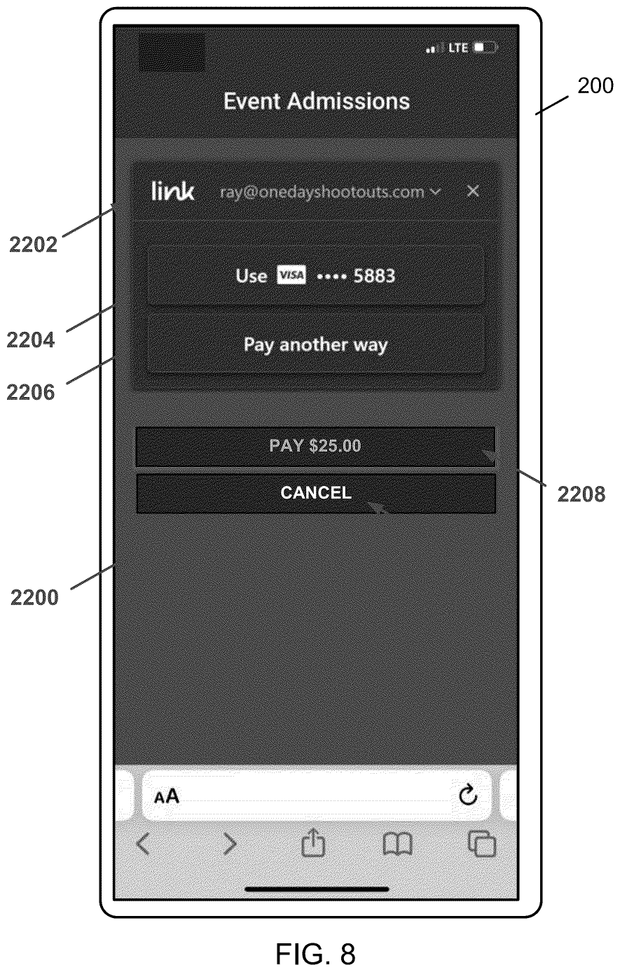

Selecting by a user the “Buy Tickets $25.00” button results in the display of GUI 2200 illustrated in the screenshot of FIG. 8. GUI 2200 comprises user-selectable input element 2202 for selecting an email associated with a “link” payment account; user-selectable input element 2204 in the form of a button titled with identification of a credit card saved in association with the specified “link” account for specifying a saved credit card for use in payment; user-selectable input element 2206 in the form of a button titled “Pay another way” for specifying a different manner for payment; user-selectable input element 2208 for confirming payment, which element 2208 is enabled upon selection of the credit card via element 2204; and user-selectable input element 2210 for canceling the ticket purchase transaction.

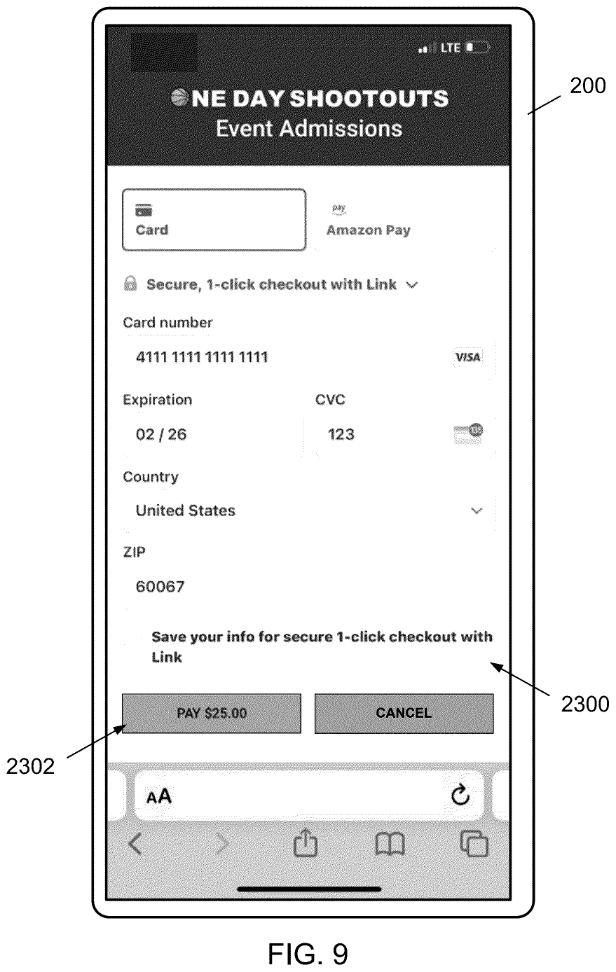

Selecting by a user the “Pay another way” button results in the display of GUI 2300 illustrated in the screenshot of FIG. 9, which GUI 2300 enables a user to enter information of a different credit card for payment or to specify use of “Amazon Pay”. Upon entering credit card information as shown in FIG. 9, user-selectable element 2302 in the form of a button titled “PAY $25.00” is enabled for selection by a user.

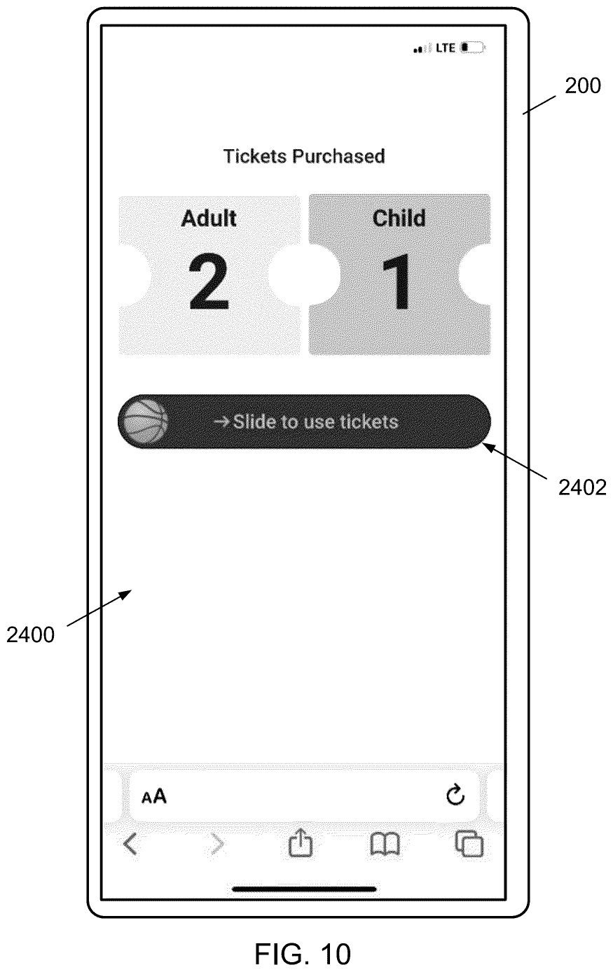

Once enabled, selecting by a user the user-selectable element 2302 in the form of the button titled “PAY $25.00” results in the display of GUI 2400 illustrated in the screenshot of FIG. 10, which GUI 2400 confirms to the user that the purchase of the specified tickets. GUI 2400 comprises a user-selectable input element 2402 in the form of a slide button titled “Slide to use tickets”. No other user-selectable elements are included within the GUI 2400; no further action needs be taken by the user within the web application until the user is ready to present the tickets for admission to the event, at which time the user slides the image of the basketball in element 2402 from left to right to indicate the user is ready to use the tickets.

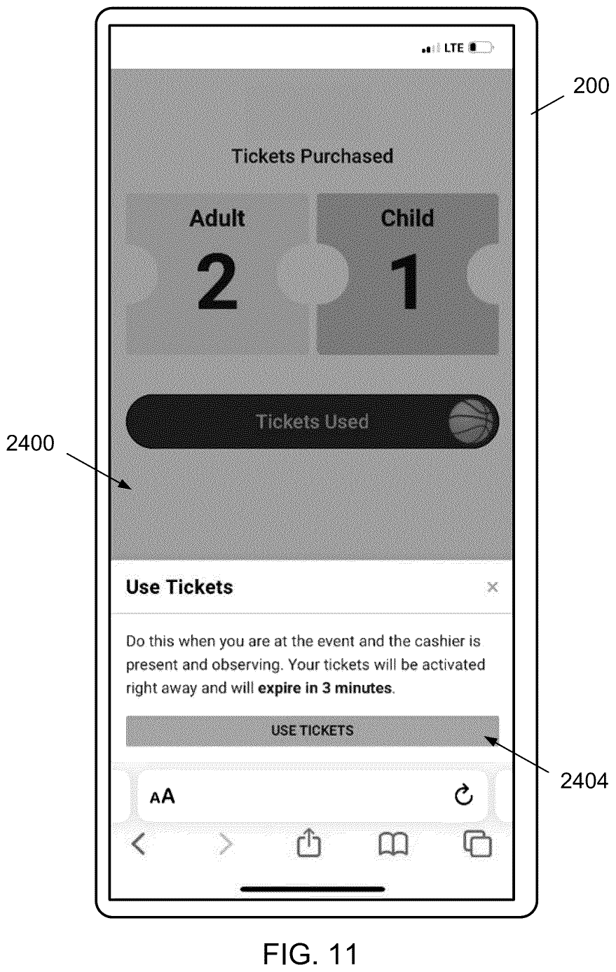

Upon sliding the basketball in element 2402, a popup window is presented in GUI 2400 for confirming, by the user, the user's intent to use the tickets for admission at this time, as shown in FIG. 11. Upon confirmation by selection of user-selectable element 2404 titled “USE TICKETS”, the tickets are activated insofar as the tickets can be presented for admission to the event within a predetermined window of time beginning with such user confirmation. Importantly, once the tickets are activated, the tickets must be presented within the predetermined time for admission; following the predetermined time the tickets are no longer usable for admission to the event. Preferably, the tickets are activated once the user has arrived at the event and is at the person who granting admission to the event, such as a cashier or a “ticket taker”, who can observe the activation of the tickets by the user.

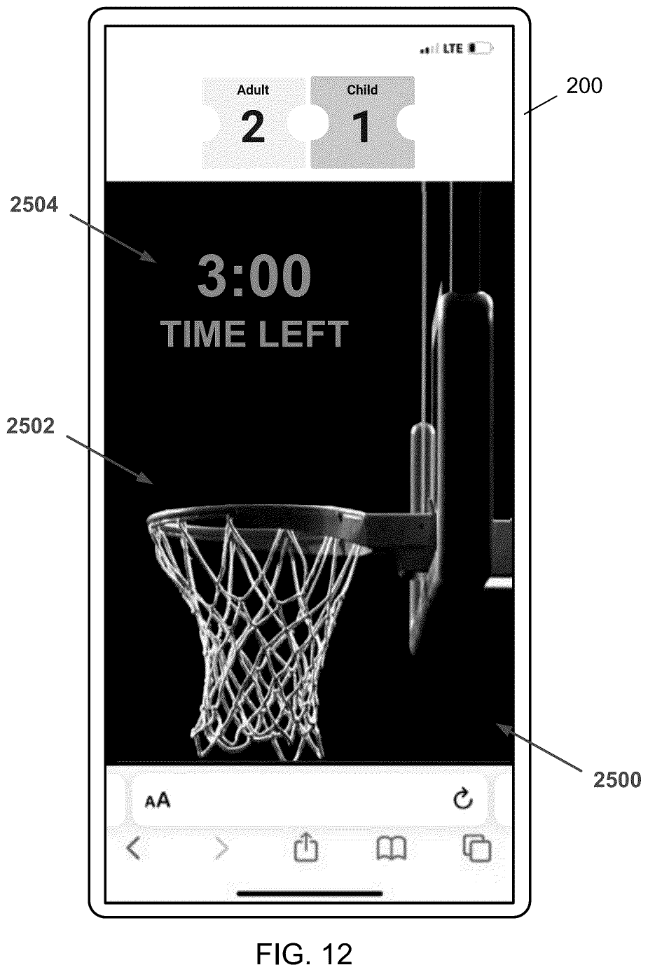

Upon confirming, by the user, the user's intent to activate and use the tickets for admission to the event be selecting element 2404, GUI 2500 is presented as shown in FIG. 12. GUI 2500 is used to authenticate the specified tickets and gain admission to the event.

Specifically, GUI 2500 displays a graphic 2502 and a countdown timer 2504. The exemplary graphic 2502 in GUI 2500 is a basketball goal. The graphic may be different for each event or for each specific instance of an event. The graphic also may be preselected by a user indicating a selection to the web application either during ticket purchasing or during a user establishing a user profile including preselection of a graphic. In any such scenario, the graphic preferably is provided by computer-executable instruction from the server-side web application to the client-side web browser for display within the GUI 2500.

The countdown timer 2504 preferably begins at three minutes and countdowns in increments of 1 second. More or less time may be selected, and the time may vary based on occurrences impacting the time required by a user to activate and gain admission to an event. In any such scenario, the time of the countdown is preferably determined by the server-side web application.

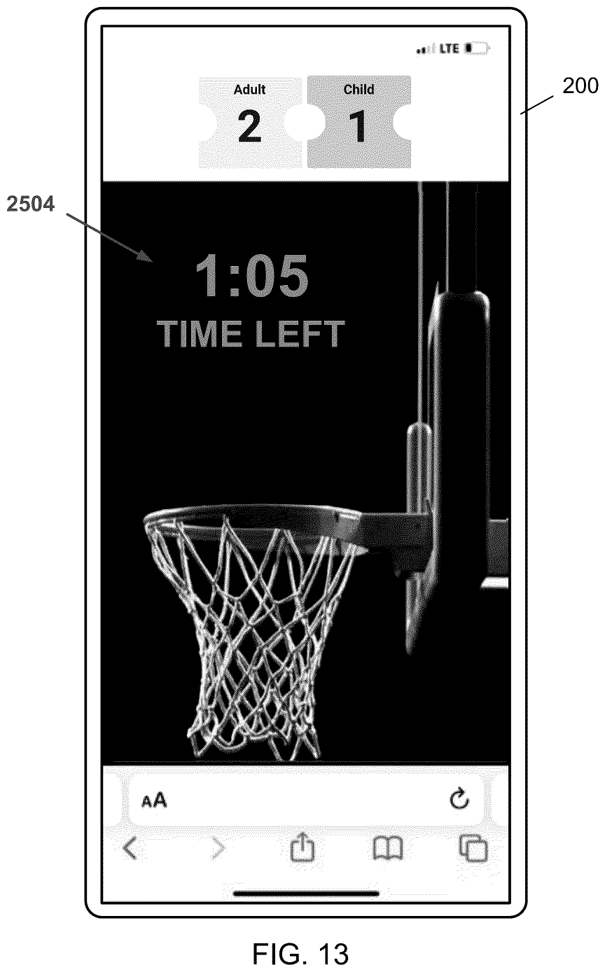

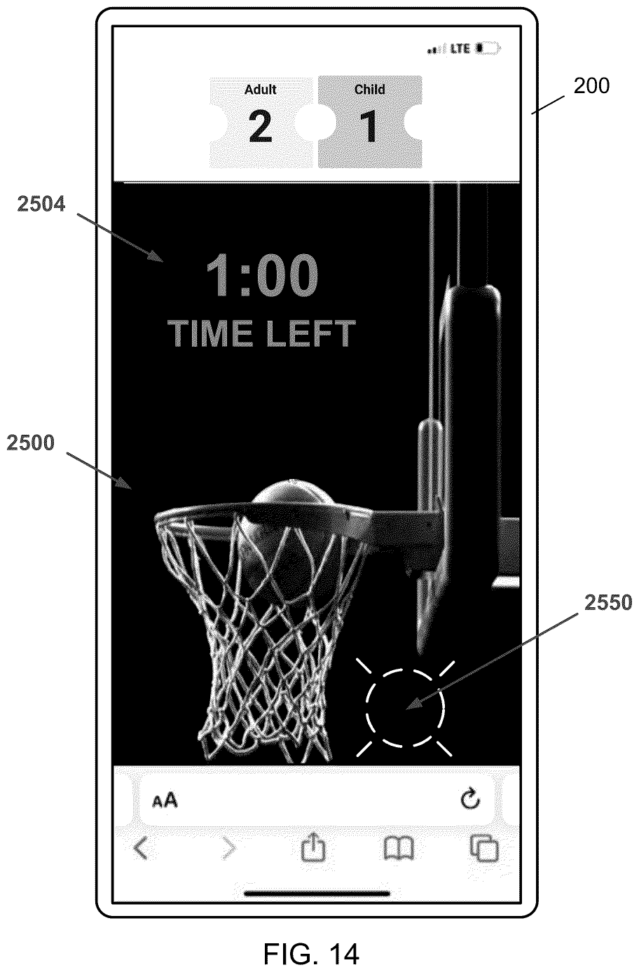

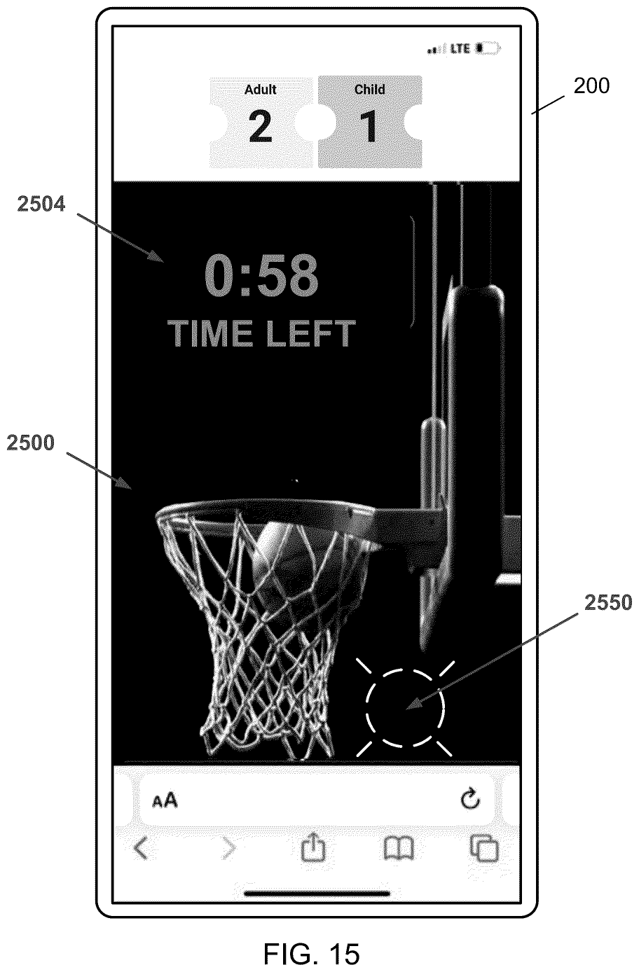

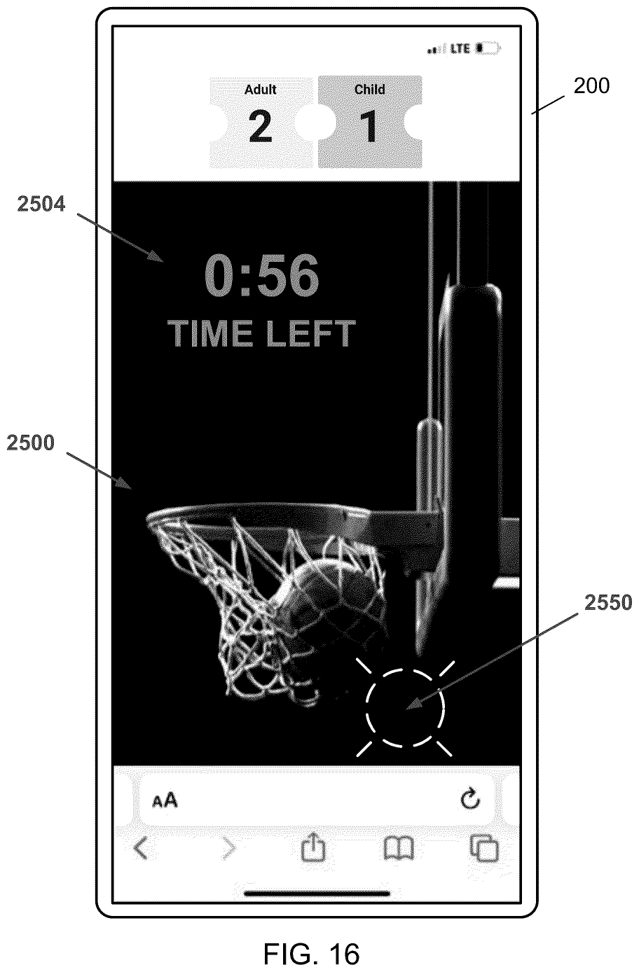

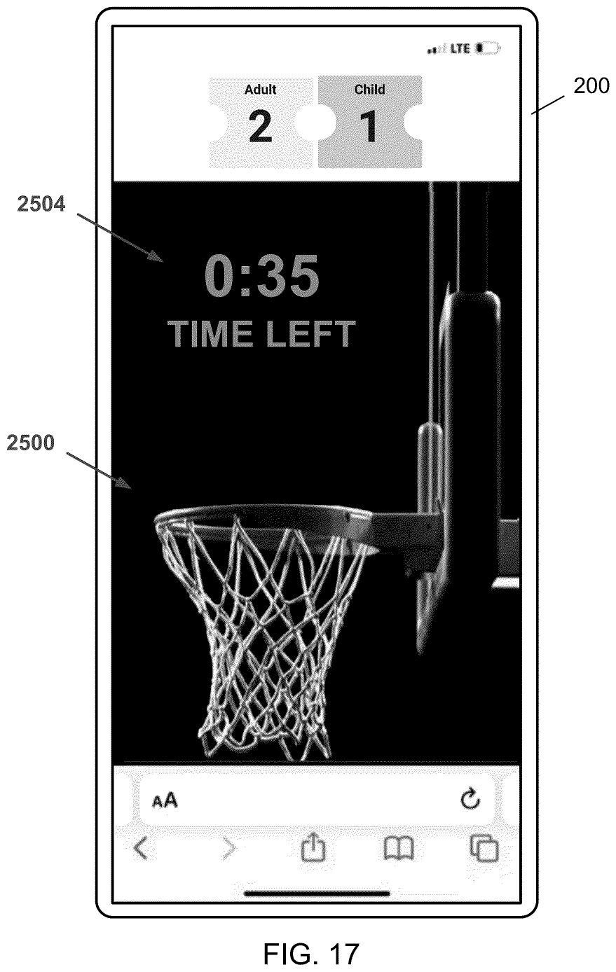

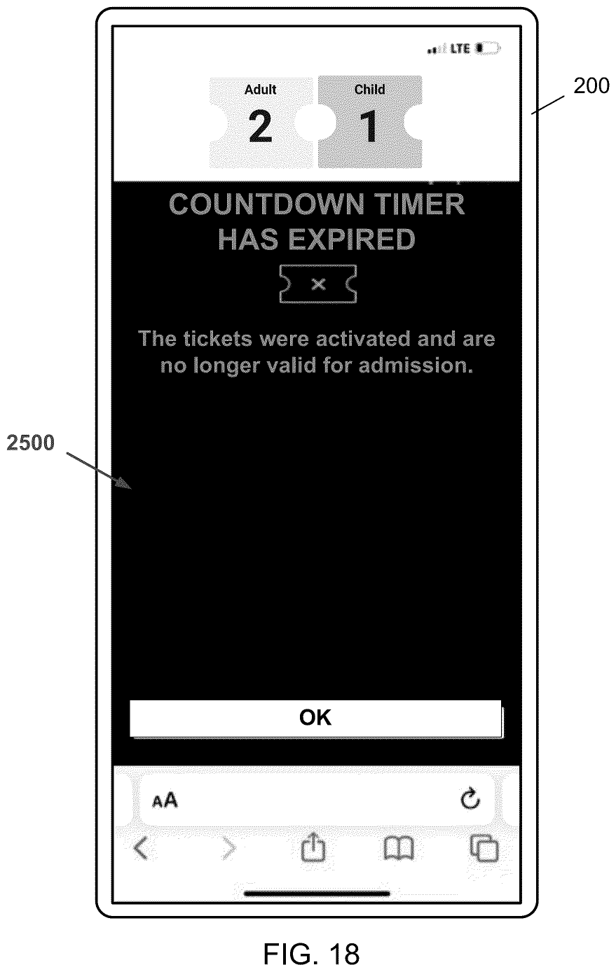

The countdown timer 2504 is shown in FIG. 12 at three minutes, in FIG. 13 at one minute and five seconds, in FIG. 14 at one minute, in FIG. 15 at fifty-eight seconds, in FIG. 16 at fifty-six seconds, and in FIG. 17 at thirty-five seconds. In FIG. 18 the countdown timer as expired and a message is displayed to the user stating: “COUNTDOWN TIMER HAS EXPIRED” and “The tickets were activated and are no longer valid for admission.” Preferably, the user must use the tickets to gain admission within the predetermined period immediately following ticket activation; after expiration of the time, the user preferably is unable to use the tickets even if the tickets were not used for admission during the predetermined period of ticket activation. Accordingly, it is very important that the predetermined period of time be sufficient for a user to gain admission after ticket activation and that ticket activation not be performed until such time as the user has arrived at the event and is ready to gain admission to the event.

With continued reference to FIGS. 12 through 17, GUI 2500 also preferably displays ticket information comprising the number of adult tickets purchased and the number of child tickets purchased. Other ticket information that may be provided comprises the date and time of the event, the name of the event, and any assigned seating corresponding to the tickets if not general admission, as in the case of the illustrated embodiment.

The display of the frontend client device 200 preferably comprises a touchscreen. Upon continued touching or “pressing” of the touchscreen display by a user, as indicated at 2550 in FIGS. 14-16, the graphic is animated to create a dynamic visual experience. In granting a user admission to an event, the user presents the display of the animation on the user's device 200 to the person granting admission to the event, whereby the specified tickets in the GUI 2500 are authenticated. Specifically, in the illustrated preferred embodiment, pressing the touchscreen by a user results in animated graphics of a basketball being shot through the basketball goal of the static graphic. By a user presenting this animation to the person granting admission to the event, the user and accompanying persons corresponding to the specified tickets thereby are granted admission to the event.

As with the static graphic that is displayed when the touchscreen is not being pressed, the animation may be different for each event or for each specific instance of an event, and the animation may be preselected by a user indicating a selection to the web application either during ticket purchasing or during a user establishing a user profile including preselection of a graphic and its animation. In any such scenario, the graphic preferably is provided by computer-executable instruction from the server-side web application to the client-side web browser for display within the GUI 2500. Furthermore, the person granting admission to the event preferably has advanced knowledge of the possible animations that may be presented for an event or for an instance of an event whereby ticket authentication by such person may be performed.

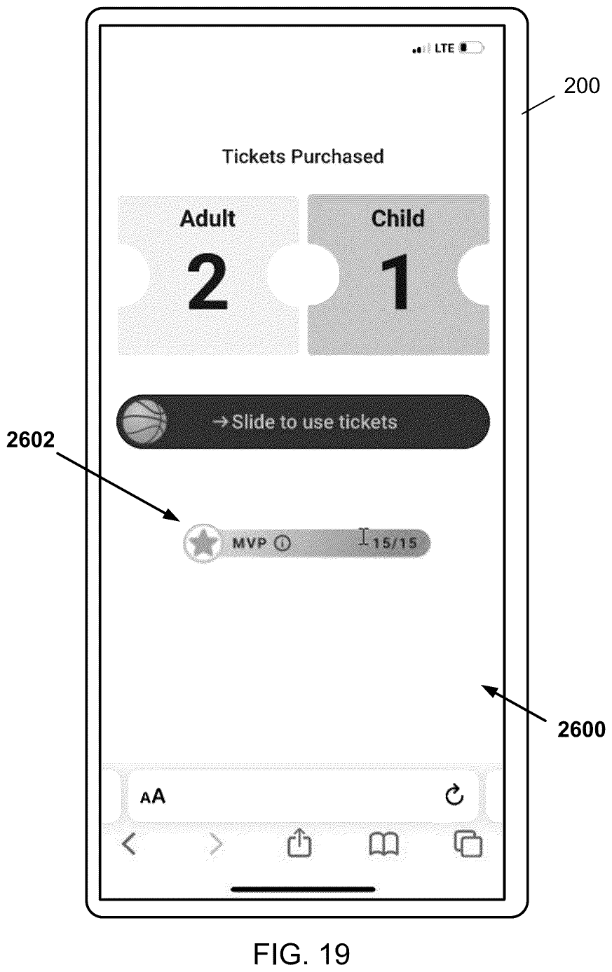

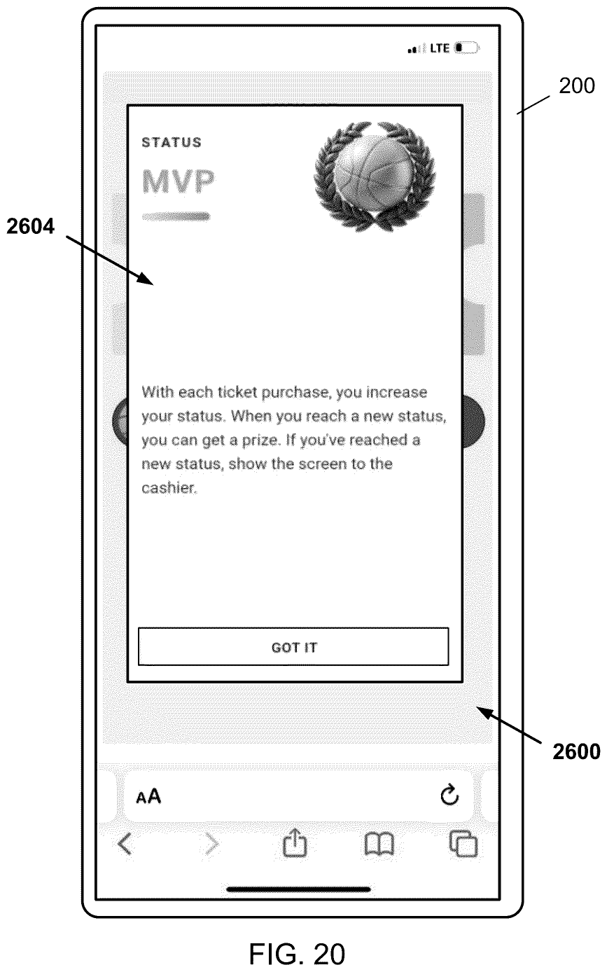

In at least some preferred embodiments, a loyalty program is implemented. A GUI 2600 of such an embodiment is shown in FIG. 19. GUI 2600 is similar to that of FIG. 10 and differs in that GUI 2600 additionally comprises user-selectable element 2602 in the form of a badge titled “MVP”. The badge includes an information icon inviting user selection of the element 2602, an icon of a star, and a display of a fraction (shown as 15/15 in the illustrated GUI 2600). The fraction represents progress in the form of a percentage toward qualifying for a loyalty level of the badge. In the illustration of FIG. 19, the MVP level of the badge has been obtained. Here, the numerator represents the number of events for which tickets have been purchased through the web application over the number required to reach the MVP level. These numbers alternatively may represent the number of tickets purchased regardless of the number of events. Benefits such as prizes or discounts may be provided corresponding to a loyalty level. Selecting by a user element 2602 results in a popup box 2604 being displayed as shown in FIG. 20. The popup box 2604 preferably displays information regarding the loyalty level including any benefits or applicable discounts to which a user reaching such level may be entitled.

It will be appreciated that some embodiments of the invention in accordance with one or more aspects described herein enable fast and efficient ticketing processes while preventing duplicate ticket usage. Furthermore, it will be appreciated that some embodiments of the invention in accordance with one or more aspects described herein record customer's data without prompting the customer for generally available information, enhancing the user experience by reducing user input effort and time.

Based on the foregoing description, it will be readily understood by those persons skilled in the art that the invention has broad utility and application. Many embodiments and adaptations of the invention other than those specifically described herein, as well as many variations, modifications, and equivalent arrangements, will be apparent from or reasonably suggested by the invention and the foregoing descriptions thereof, without departing from the substance or scope of the invention.

Accordingly, while the invention has been described herein in detail in relation to one or more preferred embodiments, it is to be understood that this disclosure is only illustrative and exemplary of the invention and is made merely for the purpose of providing a full and enabling disclosure of the invention. The foregoing disclosure is not intended to be construed to limit the invention or otherwise exclude any such other embodiments, adaptations, variations, modifications or equivalent arrangements, the invention being limited only by the claims appended hereto and the equivalents thereof.

1-44. (canceled)

45. A method performed on a client-side portable electronic device for visual authentication of a ticketholder using the portable electronic device, comprising:
(a) receiving from a server-side web application instructions for displaying a predetermined sequence of images in a web browser on the client-side portable electronic device;
(b) in accordance with the received instructions,
(i) during a predetermined period of time,
(A) displaying the predetermined sequence of images in the web browser on the portable electronic device, and
(B) not displaying the predetermined sequence of images in the web browser on the portable electronic device,
(C) wherein the predetermined sequence of images is only displayed in the web browser during actuation of a deadman switch on the portable electronic device; and
(ii) not displaying the predetermined sequence of images in the web browser outside of the predetermined period of time; and
(c) presenting the portable electronic device during the predetermined period of time for authentication by demonstrating actuation of the deadman switch and the display of the predetermined sequence of images by the portable electronic device in accordance with the received instructions.

46. The method of claim 45, wherein the portable electronic device comprises a smartphone or tablet.

47. The method of claim 45, wherein the instructions for displaying the predetermined sequence of images are deleted from the portable electronic device immediately following the predetermined period of time.

48. The method of claim 45, wherein the predetermined period of time comprises a fixed period of time.

49. The method of claim 45, wherein a remaining time of the predetermined period of time is displayed on the portable electronic device during the predetermined period of time.

50. The method of claim 49, wherein the remaining time of the predetermined period of time is displayed using a countdown timer.

51. The method of claim 45, further comprising, in accordance with the received instructions, presenting a user-selectable element in a GUI on the portable electronic device comprising a slide button for starting the predetermined period of time.

52. The method of claim 45, wherein the deadman switch comprises a physical button on the portable electronic device that must be pressed and held for actuation of the deadman switch.

53. The method of claim 45, wherein the deadman switch comprises a touchscreen on which the predetermined sequence of images is displayed in the web browser, and wherein the touchscreen must be continuously touched for actuation of the deadman switch.

54. The method of claim 45, further comprising, in accordance with the received instructions, (a) displaying a static graphic during the predetermined period of time when not displaying the predetermined sequence of images and (b) not displaying the static graphic during the predetermined period of time when displaying the predetermined sequence of images.

55. The method of claim 45, wherein the predetermined sequence of images comprises a video clip.

56. The method of claim 45, wherein the predetermined sequence of images comprises animated graphics.

57. The method of claim 45, wherein the predetermined sequence of images comprises a display of a predetermined sequence of different colors.

58. A client-side portable electronic device for visual authentication of a ticketholder, the client-side portable electronic device comprising:
(a) a display;
(b) a user input interface configured to be actuated as a deadman switch;
(c) one or more processors; and
(d) one or more memories storing executable instructions that, when executed by the one or more processors, cause the client-side portable electronic device to:
(i) receive, from a server-side web application, display instructions for displaying a predetermined sequence of images in a web browser on the client-side portable electronic device;
(ii) during a predetermined period of time and in accordance with the display instructions,
(A) display the predetermined sequence of images in the web browser on the display when the user input interface is actuated as the deadman switch, and
(B) not display the predetermined sequence of images in the web browser on the display when the user input interface is not actuated as the deadman switch; and
(iii) not display the predetermined sequence of images in the web browser on the display outside of the predetermined period of time;
wherein the display of the predetermined sequence of images when the user input interface is actuated as the deadman switch is configured for visual authentication of the ticketholder upon presentation of the client-side portable electronic device during the predetermined period of time.

59. The client-side portable electronic device of claim 58, wherein the client-side portable electronic device comprises a smartphone or tablet.

60. The client-side portable electronic device of claim 58, wherein the user input interface configured to be actuated as the deadman switch comprises a user input selected from the group consisting of:
(a) a physical button that must be pressed and held for actuation of the deadman switch; and
(b) a touchscreen on which the predetermined sequence of images is displayed in the web browser and that must be continuously touched for actuation of the deadman switch.

61. One or more non-transitory computer-readable media storing executable instructions that, when executed by one or more processors of a client-side portable electronic device, cause the client-side portable electronic device to perform operations for visual authentication of a ticketholder using the client-side portable electronic device, the operations comprising:
(a) receiving, from a server-side web application, display instructions for displaying a predetermined sequence of images in a web browser on the client-side portable electronic device;
(b) during a predetermined period of time and in accordance with the display instructions,
(i) displaying the predetermined sequence of images in the web browser on the client-side portable electronic device while a deadman switch on the client-side portable electronic device is actuated, and
(ii) not displaying the predetermined sequence of images in the web browser on the client-side portable electronic device while the deadman switch is not actuated; and
(c) not displaying the predetermined sequence of images in the web browser outside of the predetermined period of time;
wherein the operations enable authentication of the ticketholder by demonstration, during presentation of the client-side portable electronic device within the predetermined period of time, of actuation of the deadman switch and display of the predetermined sequence of images.

62. The one or more non-transitory computer-readable media of claim 61, wherein the operations further comprise deleting the display instructions from the client-side portable electronic device immediately following the predetermined period of time.

63. The one or more non-transitory computer-readable media of claim 61, wherein the operations further comprise:
(a) presenting a user-selectable element in a GUI on the client-side portable electronic device comprising a slide button for starting the predetermined period of time; and
(b) displaying a remaining time of the predetermined period of time using a countdown timer during the predetermined period of time.

64. The one or more non-transitory computer-readable media of claim 61, wherein the predetermined sequence of images comprises a video clip, animated graphics, or a display of a predetermined sequence of different colors.
